(19) United States
(12) Patent Application Publication
(10) Pub. No.: US 2025/0290271 A1
(43) Pub. Date: Sep. 18, 2025

(54) MINING MACHINE COMPRISING AN ACTUATOR MOUNTING ARRANGEMENT

(71) Applicant: SANDVIK MINING AND CONSTRUCTION OY, Tampere (FI)

(72) Inventors: Ilkka HYVÖNEN, Tampere (FI); Tuomas VARPULA, Tampere (FI)

(21) Appl. No.: 18/861,066

(22) PCT Filed: Apr. 5, 2023
(86) PCT No.: PCT/EP2023/058910

§ 371 Date: Oct. 28, 2024

(30) Foreign Application Priority Data
Apr. 29, 2022 (EP) 22170971.0

(51) Int. Cl. E02F 3/42; E02F 9/22; E21C 33/00

(52) U.S. Cl. CPC E02F 3/422; E02F 9/2271; E21C 33/00

(57) ABSTRACT

An actuator mounting arrangement includes a mining machine having a frame and at least one mounting unit. The mounting unit includes a first mounting part having at partial recess for partially receiving a protuberance extending from an outer surface of the actuator, and a second mounting part having a recess for partially receiving the protuberance. The recesses face each other and form a support surface for the protuberance. Each of the first mounting part and the second mounting part has a through hole for receiving the actuator so that the first mounting part and the second mounting part encircle the actuator in a plane transverse of an axis of the actuator in a mounted state. The first mounting part and the second mounting part have matching holes for mounting bolts with which the first mounting part and the second mounting part are detachably mounted together.

### FIELD OF THE INVENTION

The invention relates to an actuator mounting arrangement.

Further, the invention relates to a mining machine.

### BACKGROUND OF THE INVENTION

Actuators, such as hydraulic cylinders are used various heavy-duty solutions in mining machines. An example of such a heavy-duty solution of an actuator is a hydraulic lifting cylinder of a boom of a mining machine, such as a lifting cylinder of a boom of an underground loader. Some of these actuators or hydraulic cylinders are called as trunnion cylinders due to their mounting principle to the frame of the machine. Trunnion cylinders may have trunnions that are cylindrical protrusions used as mounting points or pivoting points.

Typical mounting position of the trunnion cylinder is such that the cylinder hinge axis is parallel or nearly parallel with the boom hinge axis. In prior art solutions sideways movement of a boom may cause reduction to the lifetime of the actuator, such as the hydraulic cylinder, due to a bending moment subjected to the actuator.

An objective of the invention is to alleviate the disadvantages mentioned and to provide a novel actuator mounting arrangement.

Another objective is to provide a mining machine with an actuator mounting arrangement.

### SUMMARY

The disclosure provides a mining machine, such as an underground mining machine, and an actuator mounting arrangement.

According to first aspect, the present invention provides a mining machine comprising a frame and a boom, connected with an articulation to the frame, and an actuator for lifting and lowering the boom, wherein the mining machine comprises an actuator mounting arrangement including: a mining machine having a frame, at least one mounting unit, the mounting unit comprising: a first mounting part having a recess for partially receiving a protuberance extending from an outer surface of the actuator, and a second mounting part having a recess for partially receiving a protuberance extending from the outer surface of the actuator, the two partial recesses facing each other and forming a support surface for the protuberance, wherein each of the first mounting part and the second mounting part comprises a through hole for receiving the actuator so that the first mounting part and the second mounting part encircles the actuator in a plane transverse of an axis of the actuator in a mounted state and the actuator extends through the through holes of the first mounting part and the second mounting part of the mounting unit, wherein the first mounting part and the second mounting part have matching holes for mounting bolts with which the first mounting part and the second mounting part are detachably mounted together.

The technical effect is that the mounting unit and the actuator are movable in relation to each other, and this reduces possible bending moment. Arranging the mounting unit comprise the first mounting part and the second mounting part makes the assembly and the maintenance of the arrangement easy. The further technical effect is that the actuator mounting arrangement is well suitable for heavy duty solutions such as for mining machines e.g. for lifting actuators for booms of mining machines, such as loaders.

The actuator mounting arrangement is characterizes by that is stated in the independent claim.

Some other embodiments are characterized by what is stated in the other claims.

Inventive embodiments are also disclosed in the specification and drawings of this patent application. The inventive content of the patent application may also be defined in other ways than defined in the following claims. The inventive content may also be formed of several separate inventions, especially if the invention is examined in the light of expressed or implicit sub-tasks or in view of obtained benefits or benefit groups. Some of the definitions contained in the following claims may then be unnecessary in view of the separate inventive ideas. Features of the different embodiments of the invention may, within the scope of the basic inventive idea, be applied to other embodiments.

In an embodiment of the actuator mounting arrangement the protuberance may be a cylindrical pin extending from the outer surface of the actuator. The recess of the first mounting part may be a semi-circular recess. The recess of the second mounting part may be a semi-circular recess. The two semi-circular recesses may be facing each other and forming a circular opening for the protuberance. An advantage for this is that by arranging a cylindrical protuberance it is possible to direct the possible bending moment to a rotation movement between the actuator pin and the mounting unit.

In an embodiment the actuator may comprise two protuberances extending from the outer surface of the actuator. Each of the first mounting part and the second mounting part may comprise recesses for each of the protuberances. An advantage for this is that by arranging two protuberances to the actuator and their support surfaces to the mounting unit, a solid mechanism for reducing possible bending moments to the actuator and to the mounting arrangement.

In an embodiment the protuberances may be arranged to extend on opposite sides of the actuator. An advantage is that forces and bending moment may distribute between the protuberances.

In an embodiment the protuberances may be arranged coaxially on an axis perpendicular to a longitudinal axis of the actuator. An advantage is that the forces and bending moment may be directed easily to a suitable direction.

In an embodiment a transitional portion may be arranged between the cylindrical outer surface of the actuator and the protuberance. The transitional portion may comprise a first support surface perpendicular with the axis perpendicular to the longitudinal axis of the actuator. The transitional portion may comprise a side surface extending from the first support surface to the cylindrical outer surface of the actuator. An advantage is that the transitional portion may comprise a support surfaces that may be in contact with the counter surfaces of the mounting unit. The support surfaces and/or the side surface together with the inner surfaces of through holes may be arranged to limit a movement of the actuator in a relation to the mounting unit.

In an embodiment the first support surface may be arranged, in a mounted state, next to inner surfaces of the through holes of the first mounting part and the second mounting part of the mounting unit. The side surface together with the inner surfaces of through holes may be arranged to limit a movement of the actuator in relation to the mounting unit around on axis.

In an embodiment at least part of the outer surface of the protuberance may comprise a curved surface extending outwards between a first end of the protuberance and the second end of the protuberance. An advantage for this is that the protuberance may be arranged as a curved joint surface. The curved joint surface may enable a relational movement of the actuator and the mounting unit in various directions. This may effectively reduce bending moments due to forces subjected to the actuator from various different directions.

In an embodiment at least part of the outer surface of the protuberance may comprises a semi-spherical portion. The recess of the first mounting part may comprise a semi-spherical recess. The recess of the second mounting part may comprise a semi-spherical recess. The two said semi-spherical recesses may be facing each other and forming a counter surface for the semi-spherical portion or portions of the protuberance. By arranging the protuberance and the recesses of the mounting unit comprise semi-spherical forms effective joint surfaces may be achieved.

In an embodiment the protuberance may comprise a convex surface extending from a cylindrical outer surface of the actuator in a radial direction in relation of the longitudinal axis of the actuator. In an embodiment the protuberance may be arranged or formed on a circumference of the actuator. An advantage for these is that a good design for the joint may be reached effectively.

In an embodiment the mounting unit may comprise a pin for connecting the mounting unit to the frame of the mining machine or to a boom of the mining machine. An advantage for this is that by arranging a pin for connecting to mounting unit to the mining machine, a suitable connection for heavy duty solutions may be reached, and at a same time good maintenance features may be achieved.

In an embodiment the pin of the mounting unit may be arranged perpendicularly in relation to an axis of the protuberance of the actuator. An advantage for this is that by arranging the pin of the mounting unit and the axis of the pin like protuberance of the actuator perpendicularly with each other, the arrangement may effectively reduce the bending moment affected by lateral forces, for example lateral forces of the boom of the mining machine.

In an embodiment the actuator may be arranged to move in relation to the support surfaces of the mounting unit. An advantage for this is that arranging the actuator movable in relation with the support surfaces of the mounting unit an effective arrangement for reducing the bending moment may be achieved. Support surfaces may effectively direct the relational movement of the actuator and the mounting unit in suitable directions.

In an embodiment a connector may be arranged to a piston rod of the actuator for connecting the actuator to a boom of a mining machine. In an embodiment the connector may be a rod-eye-type connector or for example a pin-like connector.

In an embodiment of the arrangement the surface of the protuberance of the actuator and the counter surface of the mounting unit may be arranged in a sliding connection with to each other. An advantage for this is that relational sliding movements of the actuator and the mounting unit may be kept accurate, since the clearances may be kept at low level.

In an embodiment of the arrangement the actuator may be a hydraulic cylinder. In an embodiment the actuator is a pneumatic cylinder. In an embodiment the actuator is an electro-mechanical actuator. In an embodiment the actuator is a trunnion cylinder.

According to second aspect the present invention relates to a mining machine comprising a frame and a boom connected with an articulation to the frame, and an actuator for lifting and lowering the boom. According to the invention the mining machine comprises an actuator mounting arrangement according to any one of embodiments mentioned above or below, or a combination of two or more of the embodiments mentioned above or below. An advantage is that by using the actuator mounting arrangement with the mining machine a compact structure that is suitable to withstand forces and at the same time reduce the bending moment may be achieved. This may also make the assembly and maintenance of the mining machine easy.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1a is a schematical partial exploded perspective view of an embodiment of an actuator and a mounting unit of the arrangement, with a cross section of a first mounting part and a second mounting part cut in a plane A-A of FIG. 1b,

FIG. 1b is a schematical partial exploded perspective view of an embodiment of an actuator and a mounting unit of the arrangement,

FIG. 1c is a schematical perspective view of an embodiment of an actuator and a mounting unit of the arrangement,

FIG. 2a is a schematical partial exploded perspective view of an embodiment of an actuator and a mounting unit of the arrangement, with a cross section of a first mounting part and a second mounting part cut in a plane A-A of FIG. 2b,

FIG. 2b is a schematical partial exploded perspective view of an embodiment of an actuator and a mounting unit of the arrangement,

FIG. 2c is a schematical perspective view of an embodiment of an actuator and a mounting unit of the arrangement,

FIG. 3a is a schematical partial exploded perspective view of an embodiment of an actuator and a mounting unit of the arrangement, with a cross section of a first mounting part and a second mounting part in a plane A-A of FIG. 3b,

FIG. 3b is a schematical partial exploded perspective view of an embodiment of an actuator and a mounting unit of the arrangement,

FIG. 3c is a schematical perspective view of an embodiment of an actuator and a mounting unit of the arrangement,

FIG. 4 is a schematical partial cross section view of an embodiment of an actuator and a mounting unit of the arrangement,

FIG. 5 is a schematical perspective view of an embodiment of a mining machine, and

FIG. 5a is a schematical detail view an embodiment of the arrangement according to detail A of FIG. 5.

In the figures, some embodiments are shown simplified for the sake of clarity. Similar parts are marked with the same reference numbers in the figures.

### DETAILED DESCRIPTION

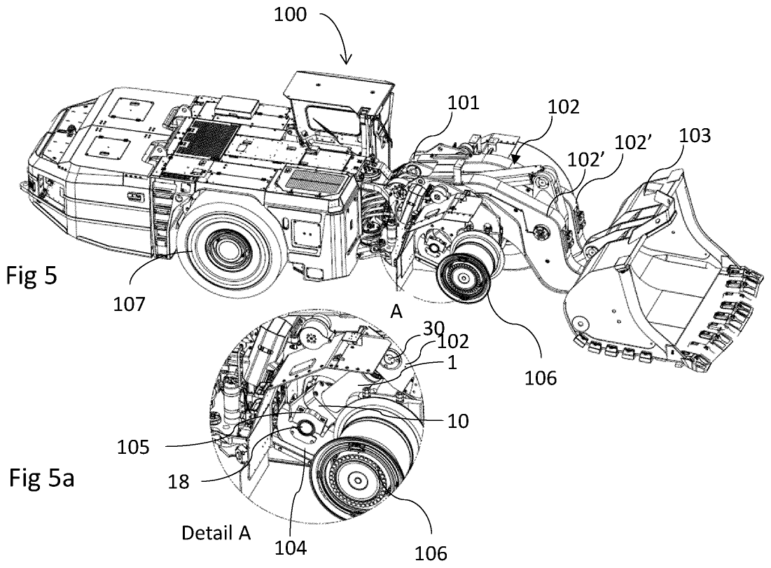

According to an aspect of the invention, the arrangement described in this description may be arranged in a mobile mining machine 100. The machine may be an underground mining machine, or a construction machine, e.g., a rock drilling rig, a development drill, a tunneling drilling machine, a surface drilling machine, a bolting or reinforcing vehicle, a rock removal machine, a longhole drill rig, an explosive charging machine, a loader, a transport vehicle, a loading or hauling machine, setting vehicles of gallery arcs or nets, a concrete spraying machine, a crusher, or a measuring vehicle. FIGS. 5 and 5a shows one example of a mobile underground mining machine 100. In an embodiment the underground mining machine may be a loader. In an embodiment the mobile underground mining machine 100 may be equipped with a boom 102. The boom 102 may be arranged movably with an articulation 101 arranged between the boom 102 and a frame 104 of the mining machine 100. In an embodiment there may be several booms arranged in the underground mining machine. In an embodiment a work tool, such as a bucket 103, may be arranged to the boom 102. In an embodiment of FIG. 5 the boom 102 may comprise two lift arms 102′ arranged side by side. The lift arms 102′ may be connected together by a binding piece or binding pieces. The boom 102 may be arranged for lifting and supporting the bucket 103. In an embodiment of the FIGS. 5 and 5a some parts, such as a tire of a front wheel 106 and covering plate, are removed for better showing the arrangement. A rear wheel 107 of the mining machine is illustrated with a tire.

An actuator 1 may be arranged on a frame 104 of the mining machine 100 with a mounting unit 10. A pin 18 of the mounting unit 10 may be connected by a mounting part 105 to the frame 104 of the mining machine 100. A connector 30 may be arranged on a piston rod of the actuator 1 and connected on a boom 102 of the mining machine. In an embodiment the boom 102 may be lifted and lowered i.e., rotated in relation to the articulation 101 between the boom and the frame 104, by the actuator 1. In an embodiment an axis of the pin 18 of the mounting unit 10 and an axis of the connector 30 of the actuator piston rod may be arranged substantially parallel with each other and the boom hinge axis 101. In prior art solutions sideways movement of a boom may cause reduction to the lifetime of the actuator, such as the hydraulic cylinder, due to a bending moment subjected to the actuator. However, with an embodiment of the actuator mounting arrangement according to the present disclosure the bending moment may be reduced. In an embodiment of the arrangement the actuator 1 may be arranged movably in relation to support surface arranged in the mounting unit 10.

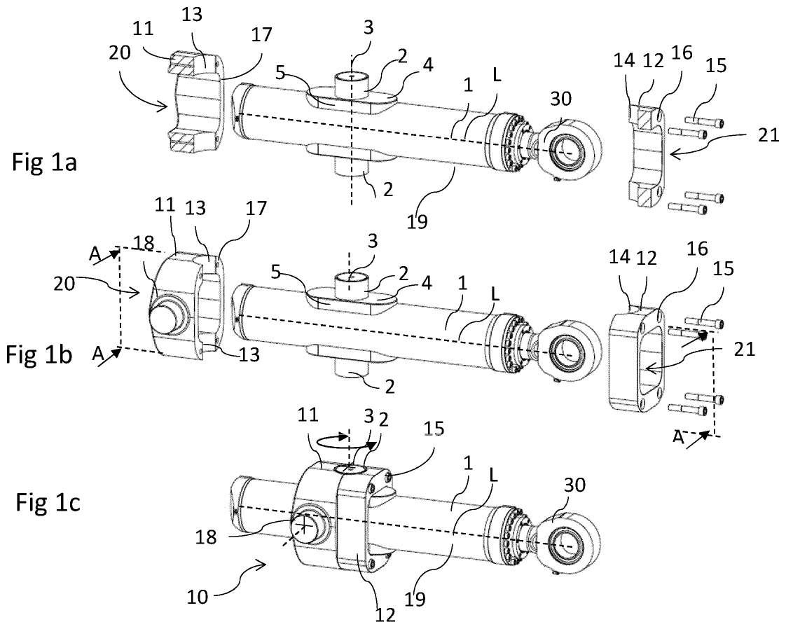

FIGS. 1a to 1c illustrates an embodiment of the arrangement.

In an embodiment of an actuator mounting arrangement may include: a mining machine 100 having a frame 104, at least one mounting unit 10, the mounting unit 10 may comprise: a first mounting part 11 having a recess 13 for partially receiving a protuberance 2 extending from an outer surface 19 of the actuator 1, and a second mounting part 12 having a recess 14 for partially receiving a protuberance 2 extending from the outer surface 19 of the actuator 1. The two partial recesses 13, 14 may face each other and form a support surface for the protuberance 2. Each of the first mounting part 11 and the second mounting part 12 may comprise a through hole 20, 21 for receiving the actuator 1 so that the first mounting part 11 and the second mounting part 12 may encircle the actuator 1 in a plane transverse of a longitudinal axis L of the actuator in a mounted state. The actuator 1 may extend through the through holes 20, 21 of the first mounting part 11 and the second mounting part 12 of the mounting unit 10. The first mounting part 11 and the second mounting part 12 may have matching holes 16, 17 for mounting bolts 15 with which the first mounting part and the second mounting part are detachably mounted together.

In an embodiment the protuberance 2 may be a cylindrical pin extending from the outer surface 19 of the actuator 1. The recess 13 of the first mounting part 11 may be a semi-circular recess. The recess 14 of the second mounting part 12 may be a semi-circular recess. The two semi-circular recesses may be facing each other and forming a circular opening for the protuberance 2. In an embodiment surfaces of recesses 13, 14 may form a counter surface for the cylindrical side surface of the protuberance with a form of the cylindrical pin.

In an embodiment the actuator 1 may comprise two protuberances 2 extending from the outer surface 19 of the actuator 1. In an embodiment each of the two protuberances 2 may have a form of a cylindrical pin. In an embodiment each of the first mounting part 11 and the second mounting part 12 may comprise a recess and/or recesses 13, 14 for each of the protuberances 2.

In an embodiment the protuberances 2 may be arranged to extend on opposite sides of the actuator 1. In an embodiment according to FIGS. 1a to 1c the first protuberance may be arranged to extend upwards in a vertical direction and the second protuberance may be arranged to extend downwards in a vertical direction. In an embodiment the protuberances 2 may be arranged coaxially on an axis 3 perpendicular to a longitudinal axis L of the actuator 1. In an embodiment the protuberances 2 may be arranged extending diametral relation to each other on a cylindrical surface of the actuator 1.

In an embodiment a transitional portion may be arranged between the cylindrical outer surface 19 of the actuator 1 and the protuberance 2. The transitional portion may comprise a first support surface 4 perpendicular with the axis 3 perpendicular to the longitudinal axis L of the actuator 1. The transitional portion may comprise a side surface 5 extending from the first support surface 4 to the cylindrical outer surface 19 of the actuator 1.

In an embodiment the first support surface 4 may be, in a mounted state, next to inner surfaces of the through holes 20, 21 of the first mounting part 11 and the second mounting part 12 of the mounting unit 10. In an embodiment the side surface 5 together with the inner surfaces of through holes 20, 21 may be arranged to limit a movement of the actuator 1 in relation to the mounting unit around on axis 3.

By enabling a relative movement between the actuator 1 and the mounting unit 10 the effects of the bending moment may be effectively reduced. In an embodiment the relative movement may be for example a small rotation movement around an axis that is perpendicular to a connection axis direction of the mounting unit to the machine frame.

In an embodiment at least part of the outer surface of the protuberance 2 may comprise a curved surface extending outwards between a first end 22 of the protuberance and the second end 23 of the protuberance 2.

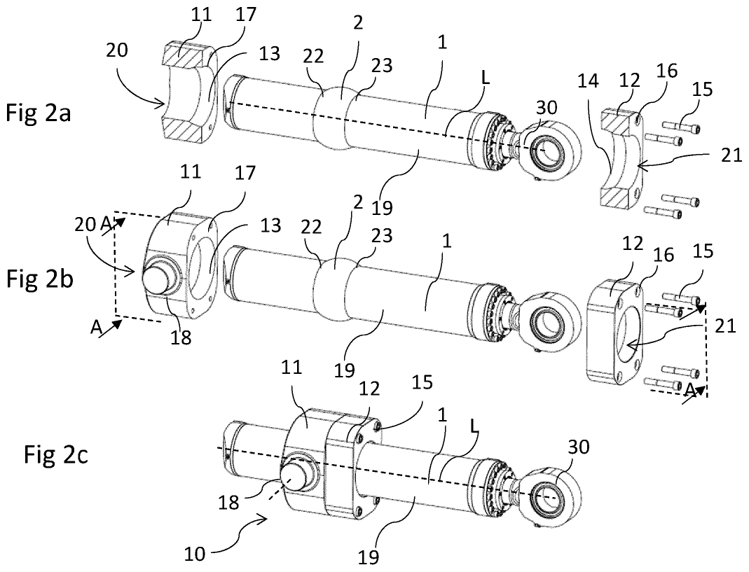

In an embodiment at least part of the outer surface of the protuberance 2 may comprise a semi-spherical portion. The recess 13 of the first mounting part 11 may comprise a semi-spherical recess. The recess 14 of the second mounting part 12 may comprise a semi-spherical recess. The two semi-spherical recesses 13, 14 may be facing each other and forming a counter surface for semi-spherical portions of the protuberance 2. In an embodiment of FIGS. 2a, 2b and 2c may comprise curved and/or semi-spherical surfaces for protuberance. The recesses 13, 14 of the mounting unit 10 may also comprise curved and/or semi-spherical surfaces that may form counter surfaces for the corresponding surfaces of the protuberance 2.

In an embodiment the protuberance 2 may comprise a convex surface extending from a cylindrical outer surface 19 of the actuator 1 in a radial direction in relation of the longitudinal axis L of the actuator.

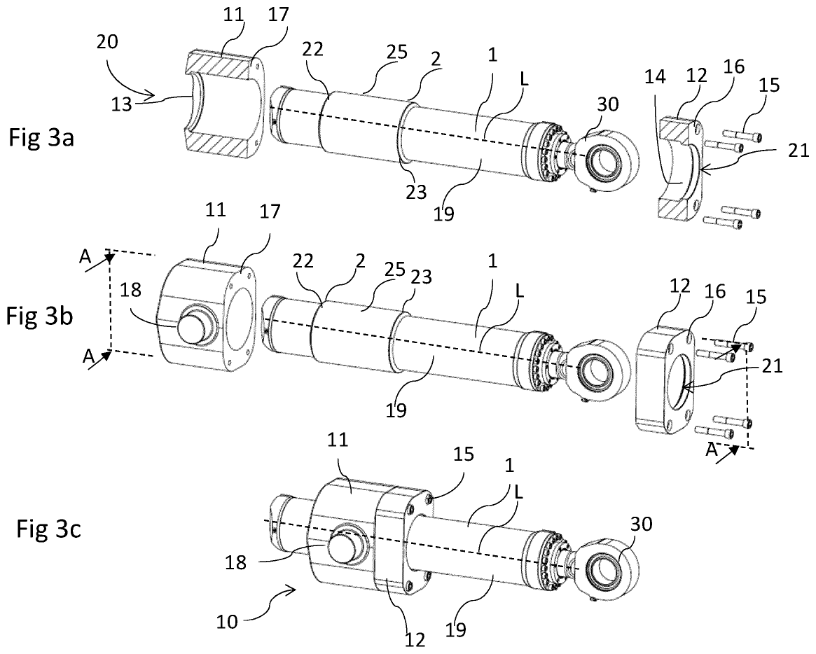

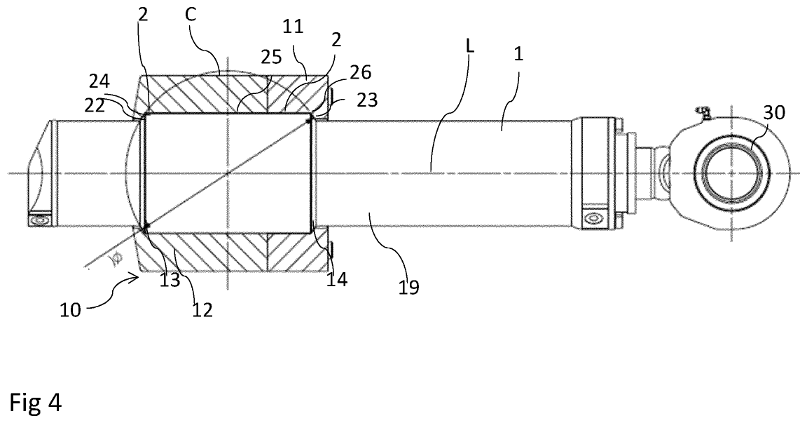

FIGS. 3a to 3c and 4 illustrate a further embodiment of the arrangement. In an embodiment a curved surface 24, 26 of the protuberance 2 may be arranged on a first end 22 of the protuberance 2 and on a second end 23 of the protuberance 2. In an embodiment the curved surface 24, 26 of the protuberance may be a semi-spherical. As illustrated in FIG. 4 curved surfaces 24, 26 of the actuator 1 are touching a circle C drawn in a plane planar to longitudinal axis L of the actuator 1. This means that each of the curved surfaces 24, 26 may form curved surfaces and/or semi-spherical surfaces. The first mounting part 11 and the second mounting part 12 may have recesses 13, 14 having a counter surface for the curved and/or spherical surfaces 24,26 of the protuberance 2. The actuator 1 may be arranged movable in relation to the mounting unit via making surfaces 24, 26 slidable with the counter surfaces of the recesses 13, 14. A surface 25 between these curved surfaces may be cylindrical. Cylindrical surface 25 of the protuberance and an inner surface of the through hole 20, 21 may have a clearance that allows movement between the actuator 1 and the mounting unit 10. This rather small relative movement may effectively reduce the disadvantages of the bending moment.

In an embodiment the mounting unit 10 may comprise a pin 18 for connecting the mounting unit 10 to the frame 104 of the mining machine 100. In an embodiment the other end of the actuator i.e., the piston rod, may comprise a connector 30 for connecting the piston rod to the boom 102.

In an embodiment the actuator 1 may be arranged so that the pin 18 for connecting the mounting unit 10 may be connected to a boom 102 of the mining machine 100 and the connector 30 of the piston rod may be connected to the frame 104 of the mining machine 100.

In an embodiment the pin 18 of the mounting unit 10 may be arranged perpendicularly in relation to an axis 3 of the protuberance 2 of the actuator 1.

In an embodiment the actuator 1 may be arranged to move in relation to support surfaces and/or recesses 13, 14 of the mounting unit 10.

In an embodiment a mining machine 100 may comprise a frame 104. In an embodiment the machine may further comprise a boom 102 connected rotatably to the frame 104. The boom may be connected rotatably to the frame around an axis of an articulation 101. The mining machine may further comprise an actuator 101 for lifting the boom 102. The mining machine 100 may comprise an actuator mounting arrangement 10 according to any one of embodiments mentioned above alone or in combination with at least one other embodiment. FIGS. 5 and 5a illustrates embodiments of the mining machine. In an embodiment the mining machine may be a loader.

It is obvious to a person skilled in the art that with the advancement of technology, the basic idea of the invention may be implemented in various ways. The invention and its embodiments are thus not limited to the examples described above, instead they may vary within the scope of the claims.

1. A mining machine comprising:
a frame and a boom, connected with an articulation to the frame;
an actuator arranged for lifting and lowering the boom;
an actuator mounting arrangement including at least one mounting unit, the mounting unit comprising:
a first mounting part having a first recess arranged for partially receiving at least one protuberance extending from an outer surface of an actuator, and
a second mounting part having a second recess arranged for partially receiving the at least one protuberance, the first and second recesses facing each other and forming a support surface for the protuberance, wherein each of the first mounting part and the second mounting part includes a through hole arranged for receiving the actuator so that the first mounting part and the second mounting part encircles the actuator in a plane transverse of an axis of the actuator in a mounted state and the actuator extends through the through holes of the first mounting part and the second mounting part of the mounting unit, and wherein the first mounting part and the second mounting part have matching holes for mounting bolts with which the first mounting part and the second mounting part are detachably mounted together; and
a transitional portion arranged between the cylindrical outer surface of the actuator and the protuberance, wherein the transitional portion includes a first support surface extending parallel with the longitudinal axis of the actuator and a side surface extending from the first support surface to the cylindrical outer surface of the actuator.

2. The mining machine according to claim 1, wherein the at least one protuberance is a cylindrical pin extending from the outer surface of the actuator, wherein the first recess of the first mounting part is a semi-circular recess, wherein the second recess of the second mounting part is a semi-circular recess, and wherein the two semi-circular recesses face each other to form a circular opening for the protuberance.

3. The mining machine according to claim 1, wherein the at least one protuberance is two protuberances, each of the two protuberances extending from the outer surface of the actuator, and wherein one of the two protuberances is received in each of the first and second recesses.

4. The mining machine according to claim 3, wherein the protuberances are arranged to extend on opposite sides of the actuator.

5. The mining machine according to claim 3, wherein the protuberances are arranged coaxially on an axis perpendicular to the longitudinal axis of the actuator.

6. (canceled)

7. The mining machine according to claim 1, wherein the first support surface is arranged, in a mounted state, next to inner surfaces of the through holes of the first mounting part and the second mounting part of the mounting unit, and wherein the side surface together with the inner surfaces of through holes are arranged to limit a movement of the actuator in relation to the mounting unit around axis.

8. The mining machine according to claim 1, wherein at least part of the outer surface of the at least one protuberance includes a curved surface extending outwards between a first end of the at least one protuberance and the second end of the at least one protuberance.

9. The mining machine according to claim 1, wherein at least part of the outer surface of the at least one protuberance includes a semi-spherical portion, and the recess of the first mounting part includes a semi-spherical recess, and the recess of the second mounting part includes a semi-spherical recess, and wherein the two semi-spherical recesses are facing each other and form a counter surface for semi-spherical portions of the at least one protuberance.

10. The mining machine according to claim 1, wherein the at least one protuberance includes a convex surface extending from a cylindrical outer surface of the actuator in a radial direction in relation of the longitudinal axis of the actuator.

11. The mining machine according to claim 1, wherein the mounting unit includes a pin for connecting the mounting unit to the frame of the mining machine or to a boom of the mining machine.

12. The mining machine according to claim 11, wherein the pin of the mounting unit is arranged perpendicularly in relation to an axis of the protuberance of the at least one actuator.

13. The mining machine according to claim 1, wherein the actuator is arranged moveably in relation to the support surfaces of the mounting unit.

14. The mining machine according to any one of claims 1 to 13, wherein a connector is arranged on a piston rod of the actuator for connecting the actuator to the boom of the mining machine.
